(19) United States
(12) Patent Application Publication
(10) Pub. No.: US 2008/0263140 A1
(43) Pub. Date: Oct. 23, 2008

(54) Network System, Server, Client, Program and Web Browsing Function Enabling Method

(75) Inventors: Masato Yoshikawa, Tokyo (JP); Akihisa Kurashima, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 12/084,319

(22) PCT Filed: Oct. 24, 2006
(86) PCT No.: PCT/JP2006/321602

§ 371 Date: Jun. 19, 2008

(30) Foreign Application Priority Data
Nov. 1, 2005 (JP) 2005-318508

(51) Int. Cl. G06F 15/16

(52) U.S. Cl. 709/203

(57) ABSTRACT

A network system is provided which can ensure that the user's operability will not decrease even when the number of functions increases and that a display screen will be as intended by the creator of the content. In the network system, a main server receives a request for a web content received from a client connected with the main server via a network, acquires the web content from a web server and provides it to the client. The main server provides to the client function setting information which contains information indicating the type and location of a function available for execution by the client on the web content. The client executes the web content and executes on the web content the function which the client has invoked based on the information which indicates the location of the function and which is contained in the function setting information acquired from the main server.

### TECHNICAL FIELD

The present invention relates to web browsing via various communication terminals, such as cell phones, PDA, notebook PCs and desktop PCs. More particularly, the invention relates to a network system, server, client, program and web browsing function realizing method to display a function menu corresponding to the currently focused link information and then to invoke the selected function.

### BACKGROUND ART

An example of this kind of web browsing scheme for enabling the use of browser functions is the one disclosed in Japanese Patent Laying-Open No. 2004-5330 (Document 1).

FIG. 16 is a block diagram which shows an example of the system configuration of a web browsing scheme used in this related art to enable the use of browser functions.

Referring to FIG. 16, when a web server 1000 transmits an HTML-form homepage 1002 to a web browser 1010, the web browsing scheme to enable the use of browser functions first invokes the edit program 1001 which has already been placed in the homepage and then automatically embeds the code which describes the necessary function into the HTML page 1002. It is this newly generated HTML page that the web server 1000 actually transmits to the web browser 1010.

Document 1: Japanese Patent Laying-Open No. 2004-5330

The web browsing scheme to enable the use of browser functions disclosed in Document 1, however, has two major problems. Firstly, since the scheme adds as many links as the number of functions to each of the links within an HTML, the screen content becomes increasingly complex as the number of functions increases, ultimately resulting in lower operability experienced by users. Secondly, a display screen may not be as intended by the creator of the HTML page because adding links to the original HTML page may very often compromise the layout of the display screen.

The object of the present invention is to provide a network system, server, client, program, web browsing function realizing method which can solve the above-described problems by preventing the operability experienced by users from becoming lower as the number of functions increases and by ensuring that a display screen looks as intended by the creator of the content.

### SUMMARY

According to an exemplary aspect of the invention, a network system in which a main server receives a request for a content from a client connected with the main server via the network, acquires the content from a content server and provides the content to the client, wherein the main server providing to the client at least one of first function setting information which contains information indicating the types and locations of functions available for execution by the client on the content and second function setting information which contains information indicating the types, function names and locations of functions available for execution by the client on the content; and the client executing the content and executing on the content the function which the client has invoked based on the information which indicates the location of the function and which is contained in the first or second function setting information acquired from the main server.

### BRIEF DESCRIPTION OF THE DRAWINGS

FIG. 1 is a block diagram which shows the configuration of a first exemplary embodiment of the present invention;

FIG. 2 is a diagram which shows the function menu setting information used by the first exemplary embodiment of the invention;

FIG. 3 is a diagram which shows the direct selection function setting information used by the first exemplary embodiment of the invention;

FIG. 4 is a block diagram which shows the hardware configuration of client hardware according to the first exemplary embodiment of the invention;

FIG. 5 is a diagram which shows the operation sequence for the first exemplary embodiment of the invention;

FIG. 6 is a diagram which shows the operation sequence for the first exemplary embodiment of the invention;

FIG. 7 is a diagram which shows the operation flow of the first exemplary embodiment of the invention;

FIG. 8 is a diagram which shows the screen configuration of the first exemplary embodiment of the invention;

FIG. 9 is a diagram which shows the operation flow of the first exemplary embodiment of the invention;

FIG. 10 is a diagram which shows the operation sequence and the function menu setting information for direct selection for the first exemplary embodiment of the invention;

FIG. 11 is a diagram which shows the screen configuration of a second exemplary embodiment of the invention;

FIG. 12 is a diagram which shows the function menu setting information used by the second exemplary embodiment of the invention;

FIG. 13 is a diagram which shows the operation sequence for the second exemplary embodiment of the invention;

FIG. 14 is a block diagram which shows the configuration of a third exemplary embodiment of the invention;

FIG. 15 is a diagram which shows the correspondence information used by the third exemplary embodiment of the invention; and

FIG. 16 is a block diagram which shows the system configuration of the web browsing scheme used in the related art.

### EXEMPLARY EMBODIMENT

### First Exemplary Embodiment

A first exemplary embodiment of the invention will now be described in detail with reference to the drawings.

### (Configuration of the First Exemplary Embodiment)

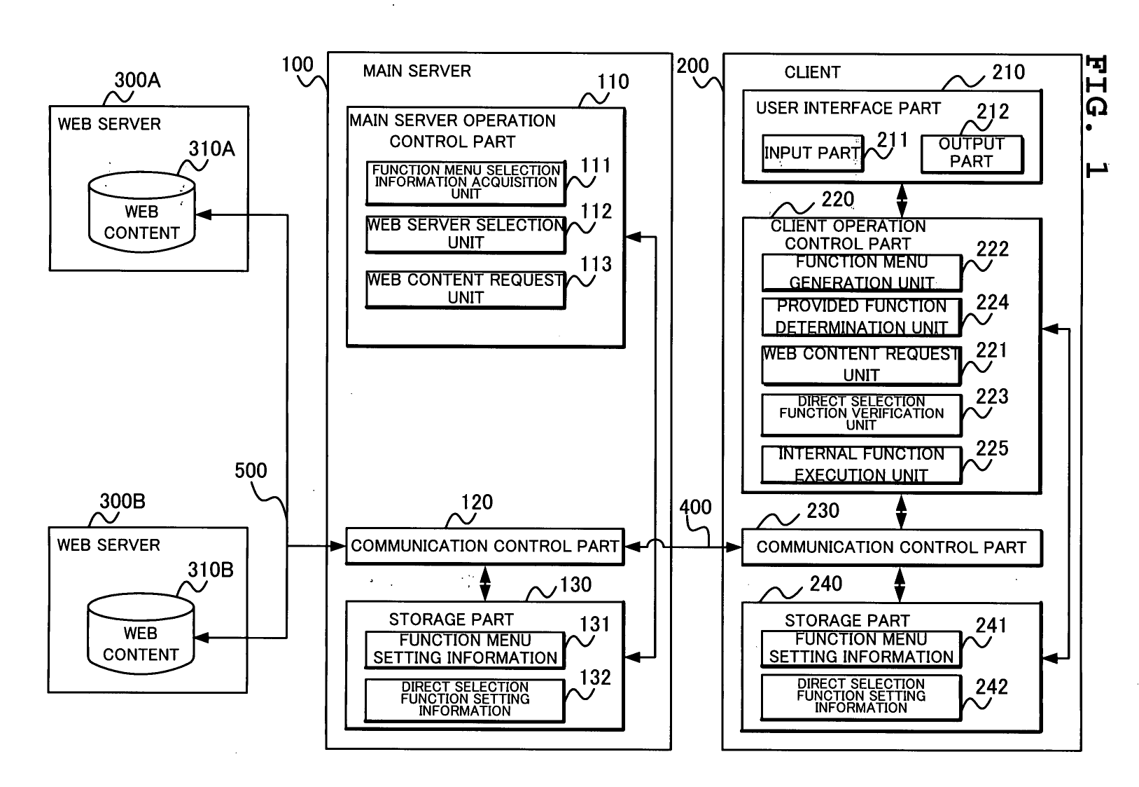

FIG. 1 is a block diagram which shows the configuration of a communication system according to the first exemplary embodiment.

As shown in FIG. 1, in the communication system according to the exemplary embodiment, a main server 100 and a client 200 are mutually connected via a network 400. The main server 100, a web server 300A and a web server 300B are mutually connected via a network 500.

The communication method used for networking in this communication system is irrelevant to the invention and thus will be omitted from the description below. While in FIG. 1 there are only one client 200, one main server 100 and two web servers 300, the number of each of the elements may be one or two or more.

The main server 100 is a server which receives from the client 200 a user's request to view a web content and responds to the request by providing the corresponding information to the client 200. Examples of main server 100 include corporate servers and servers operated by application service providers.

More specifically, the main server 100 comprises a main server operation control part 110, a communication control part 120 and a storage part 130. The main server 100 receives from the client 200 a user's request for a web content and verifies the received request. Based on the URL specified by the client 200, it then selects an appropriate web server from among the web server 300A, the web server 300B or other servers, if any, that are connected via the network 500, and issues a request for the web content to the selected web server. Finally, it provides to the client 200 the web content which it has received as a result of issuing the request for the web content.

The main server 100 may provide to the client 200 the web content acquired from the web server after converting its representation form or other attribute.

The main server operation control part 110 comprises a function menu setting information acquisition unit 111 which, based on a request for function menu setting information issued from the client 200, acquires from the storage part 130 the function menu setting information 131 (described later) that corresponds to such request; a web server selection unit 112 which, based on a request for a web content issued from the client 200, selects the web server that corresponds to such request from the web server 300A and the web server 300B; and a web content request unit 113 which issues a request for a web content to the selected web server.

The communication control part 120 has a function to communicate with external devices connected to the networks 400, 500, and is responsible for providing a web content to, for example, the client 200. When the client 200 starts and a request for function menu setting information is received from the client 200, it is also the responsibility of the communication control part 120 to provide the function menu setting information to the client 200.

The storage part 130 stores function menu setting information 131 to which a list of available functions is associated according to the classification to which each piece of link-to information belongs, along with direct selection function setting information 132 for use by the client 200 to determine whether or not a function corresponding to the function name entered directly by the user exists.

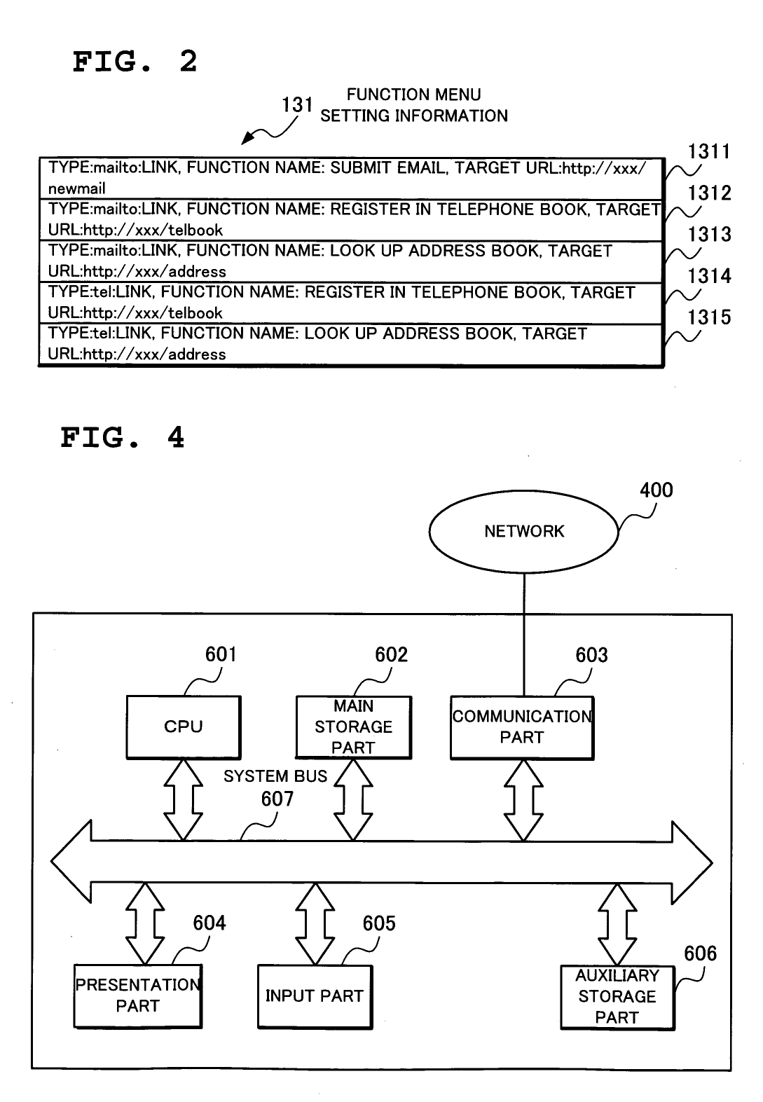

FIG. 2 is a diagram which is provided to explain the function menu setting information 131.

Referring to FIG. 2, it can be seen that the function menu setting information 131 may include function menu setting information 1311 to 1315 which consists, for example, of link-to information (the URL to be invoked), the classification (type) to which the link-to information belongs, and the information which indicates the functions (function names) available for different classifications to which link-to information belongs.

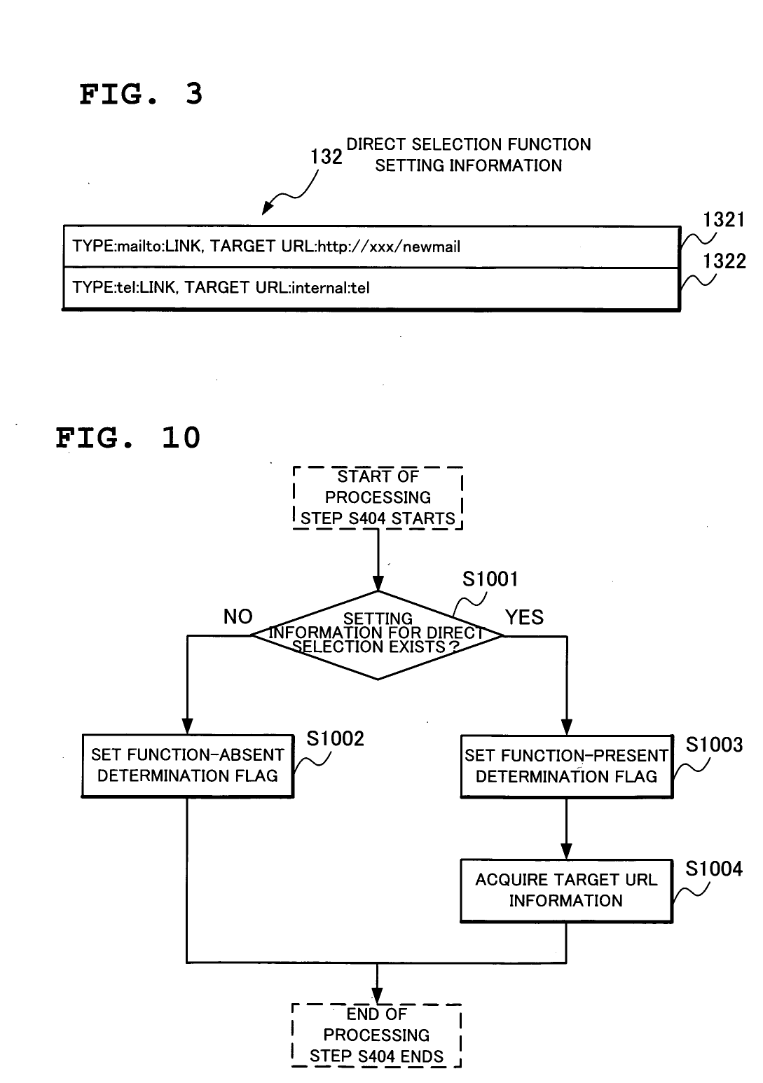

FIG. 3 is a diagram provided to explain the direct selection function setting information 132.

Referring to FIG. 3, it can be seen that the direct selection function setting information 132 may include, for example, direct selection function setting information 1321, 1322 which consists of link-to information (the URL to be invoked) and the classification (type) to which the link-to information belongs.

Setting information for direct selection 242 may be provided either in place of function menu setting information 241, separately from function menu setting information 241 or within function menu setting information 241.

In order to simplify the description of this exemplary embodiment, it is assumed that the direct selection function setting information 242 exists separately from the function menu setting information 241.

The client 200 may be any communication terminal, whether a cell phone, PDA, notebook PC or desktop PC, and comprises a user interface part 210, a client operation control part 220, a communication control part 230 and a storage part 240.

The user interface part 210 has a web browser function to display a web content received as a result of issuing a request to the main server 100. In addition, the user interface part 210 includes an input part 211, such as a keypad, keyboard or mouse, to serve as an input interface to receive input of information from the user of the client 200. It also includes an output part 212, such as a monitor capable of outputting text and images, to serve as an output interface which provides information to the user. The output part 212 can display a function menu, generated by the client operation control part 220, which corresponds to the link-to information contained in the web content.

The client operation control part 220 comprises a web content request unit 221 which issues to the main server 100 a request for a web content based on the user's request to view a web content; a function menu generation unit 222 which generates a function menu with a list of selectable functions based on the function menu setting information 241; a direct selection function verification unit 223 which verifies whether or not the function directly selected by the user actually exists based on direct selection function setting information 810 (described later); a provided function determination unit 224 which determines whether the function to be provided is an external or internal function; and an internal function execution unit 225 which invokes and executes one of the functions held within the client 200.

The communication control part 230 has a function to communicate with the main server 100 and other externally connected devices.

The storage part 240 has the same functions as the storage part 130 of the main server 100. That is, similarly to the storage part 130, from among the function menu setting information 131 held by the main server 100, the storage part 240 stores the function menu setting information received from the main server 100 as the function menu setting information 241. Also similarly to the storage part 130, from among the direct selection function setting information 132 held by the main server 100, the storage part 240 stores the direct selection function setting information received from the main server 100 as the direct selection function setting information 242.

The hardware configuration of the client 200 will now be described.

FIG. 4 is a block diagram which shows the hardware configuration of the client 200 according to this exemplary embodiment of the invention.

With reference to FIG. 4, the client 200 according to the invention may be realized in any hardware configuration similar to general computer devices, and comprises a CPU (Central Processing Unit) 601 (client operation control part 220); a main storage part 602 which is a main memory, such as an RAM (Random Access Memory), used as data workspace and temporary save space for data; a communication part 603 (communication control part 230) which transmits and receives data via the network 400; a presentation part 604, such as an LCD, printer and speakers; an input part 605 (user interface part 210), such as a keyboard and mouse; an auxiliary storage part 606 (storage part 240) which is a hard disc device consisting of a nonvolatile memory, such as an ROM (Read Only Memory), magnetic disc and semiconductor memory; and a system bus 607 which connects between the above-mentioned components of this information processing unit.

It goes without saying that the operations of the client 200 according to the invention can be realized in hardware form by implementing within the client 200 a circuit component which consists of an LSI (Large Scale Integration) or other hardware parts into which a program that realizes these functions is incorporated, but these operations can also be realized in software form by causing the CPU301 on the computer processing unit to execute a program which provides the functions of these components.

In other words, the CPU301 can realize the above-described functions in a software-based manner by loading a program stored in the auxiliary storage part 307 into the main storage part 302 and executing the program to control the operations of the client 200.

The main server 100 described above has a hardware configuration similar to the one described above and can realize the functions of the main server 100 in either a hardware or software form.

The web server 300A and the web server 300B have web server functions and hold web contents 310A, 310B described in a markup language, e.g., HTML and c-HTML. These web servers provide these web contents to the main server 100 in response to a request from the main server 100.

Meanwhile, the main server 100 itself may instead have web server functions and hold web contents. In this case, the main server 100 would transmit the web contents held in the main server 100 to the client 200 directly, on receiving a request for a web content from the client 200.

### (Operation of the First Exemplary Embodiment)

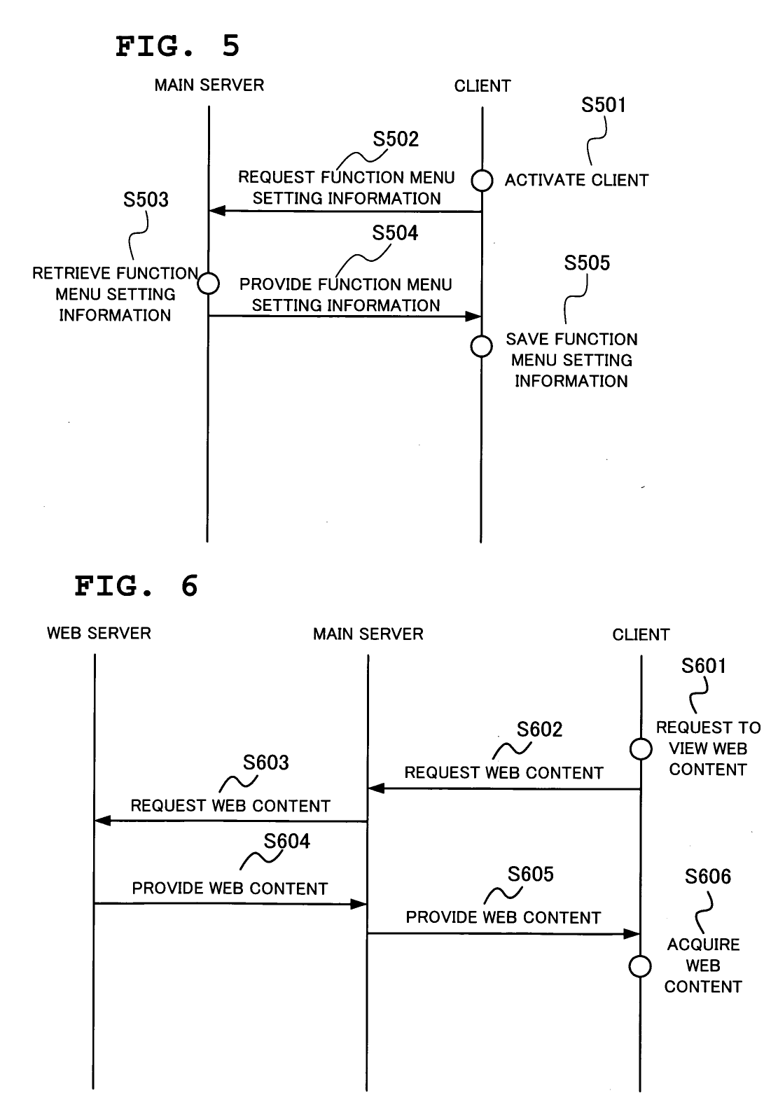

FIG. 5 is a sequence chart which shows an example operation between the main server 100 and the client 200 according to this exemplary embodiment.

With reference to FIGS. 1 and 5, the main server 100 and the client 200 which form the communication system according to this exemplary embodiment will now be explained with respect to their operations from when the client 200 holds no function menu setting information 241 until when it acquires function menu setting information from the main server 100 and saves it as the function menu setting information 241.

First, the client 200 starts, in response to the operation by the user of the client 200 (step S501). This is done on the client 200, such as a mobile terminal, PDC and PC, by starting the program which provides web browser functions.

With this operation, a request for function menu setting information is issued from the client operation control part 220 to the main server 100 via the communication control part 230 (step S502).

It is assumed that the request for function menu setting information issued as described above is a parameter which can be interpreted by the main server operation control part 110 of the main server 100 that it is a request for function menu setting information.

Next, on receiving the request for function menu setting information, the main server operation control part 110 causes the function menu setting information acquisition unit 111 to retrieve the function menu setting information corresponding to the request for function menu setting information from among the function menu setting information 131 stored in the storage part 130 of the main server 100 (step S503) and to provide the retrieved information to the requesting client 200 (step S504).

Then, the client 200 saves the function menu setting information sent from the main server 100 in the storage part 240, which is a save area, such as a hard disc drive, flash memory, cache and heap memory, held by client 200, as the function menu setting information 241 (step S505).

This completes the process by the client 200 of saving the function menu setting information 241.

The process of acquiring setting information for direct selection 242 may be performed either separately from or together with the process of acquiring the function menu setting information 241.

FIG. 6 is a sequence chart which shows the operation performed between the main server 100, the client 200 and the web servers 300A, 300B according to this exemplary embodiment.

With reference to FIGS. 1 and 6, the web content acquisition process performed among the main server 100, the client 200 and the web servers 300A, 300B, which form the above-described communication system according to this exemplary embodiment, will now be described. This process corresponds to the operation up to when the client 200 acquires a web content.

During the process in FIG. 5, after the function menu setting information 241 has been saved by the client 200, a request to view a web content is entered by the user by operating the input part 211 in the user interface part 210 of the client 200 (step S601).

When the user interface part 210 receives the request to view a web content, the client 200 issues a request for the web content to the main server 100 from the web content request unit 221 of the client operation control part 220 via the communication control part 230 (step S602).

The web content request information which represents the request for the web content consists of a parameter which indicates that this is a request issued to a web server for a web content and that it is interpretable by the main server operation control part 110 of the main server 100, along with a URL which specifies a web server.

On receiving the web content request, the main server operation control part 110 of the main server 200 requests to the web server 300A or the web server 300B, whichever corresponds to this request for the web content, for the web content via an ordinary HTTP or HTTPS access (step S603).

On receiving the request for the web content, the web server 300A or the web server 300B provides the web content 310A or the web content 310B, whichever corresponds to the web content request, to the main server 200 (step S604).

On receiving the web content 310A or the web content 310B from the web server 300A or the web server 300B via the communication control part 120, the main server operation control part 110 of the main server 100 provides the received web content to the client 200 which is the source of the request for the web content (step S605).

The client 200 receives the web content sent from the main server 100 at the communication control part 230 and acquires that web content (step S606).

This completes the web content acquisition process performed by the client 200.

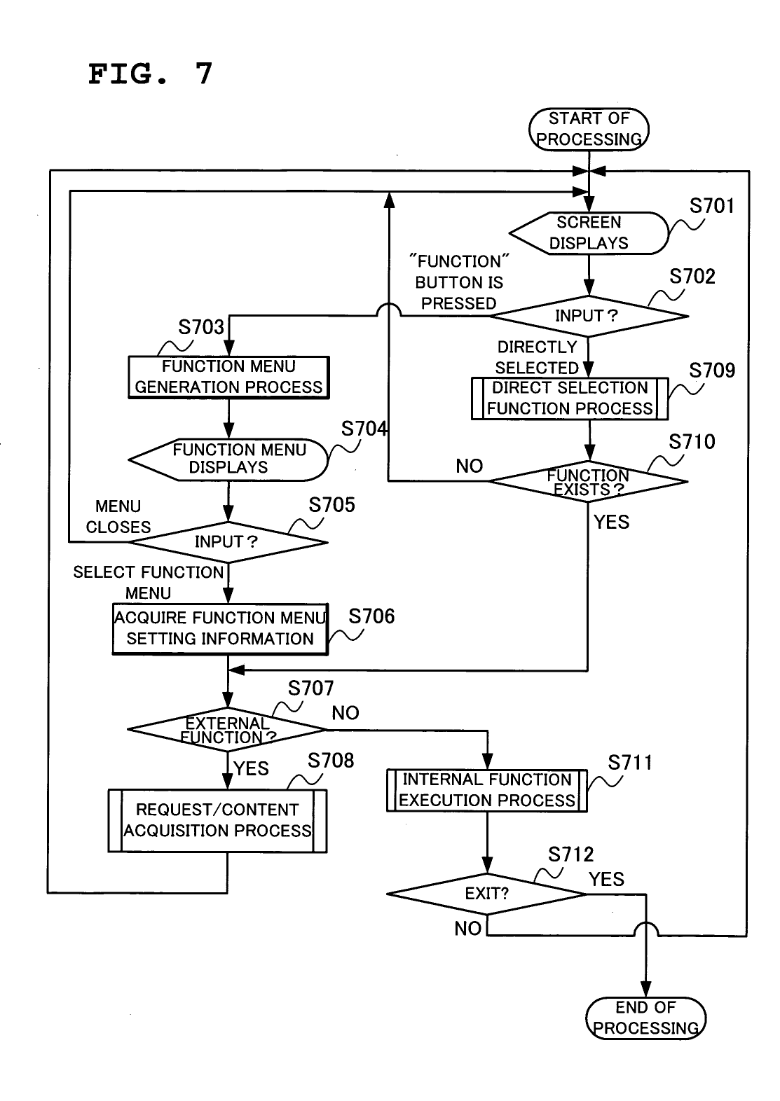

FIG. 7 is a flow chart which shows the procedure for the client 200 according to this exemplary embodiment of the invention to execute various functions.

In the description below, with reference to FIGS. 1, 2, 3, 7, 8, 9 and 10, it is explained how the client 200, which is a component of a communication system according to this exemplary embodiment, displays the acquired web content through the user interface part 210. More specifically, described herein are the process of generating a function menu by referencing the information within a link embedded in the web content (function menu generation process); the process of causing the user interface part 210 to display the acquired web content; the process of invoking a function menu assigned to a link, which takes place when the link on the web content is selected by the user; and the process which takes place when an item on the invoked function menu is selected by the user.

With reference to FIG. 7, on acquiring the web content, the client 200 performs the process of displaying a display screen on the output part 212 in the user interface part 210 (step S701).

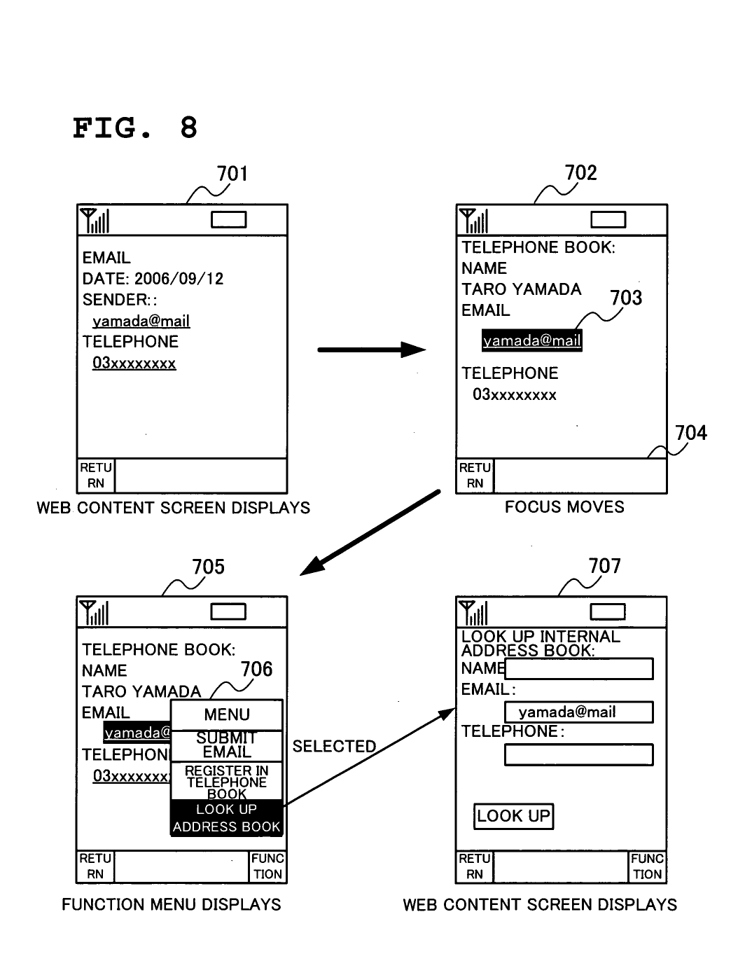

FIG. 8 is a diagram which shows the layout of an example display screen outputted by the output part 212 in the user interface part 210 of the client 200 according to this exemplary embodiment.

The client 200 displays the web content screen 701 as shown in FIG. 8 on the output part 212 and waits for input from the user.

The user can use the up/down cursor keys, shortcut keys or the mouse to move the focus through the different link tags on the screen (web content screen 702). If any of the shortcut keys assigned to various function menus, function keys or soft keys (function selection key 704 in the web content screen 702) is pressed by the user (step S702) while or immediately after the focus is on a plug-in point (focus 703 in web content screen 702), the client 200 performs the function menu generation process for the selected plug-in point (step S703).

The plug-in point herein is an item to which a function menu is assigned. An example of such plug-in point is an <A> tag.

Instead of handling an <A> tag as a single type of plug-in point, it is also possible to handle it as different types of plug-in points depending on different schema types for URLs indicated by href attributes.

A URL is defined by RFC1738. Examples of such URL schema include the mailto schema, which invokes an email function held by the client and creates an email message to a designated email address, and the tel schema, which invokes an audio call function held by the client and performs the process of calling a designated telephone number.

In addition, instead of being handled on a schema-to-schema basis, a set of different plug-in points may be handled as one type of plug-in point. For example, “http and https” or “all other than tel and mailto” may be processed as the same type of schema, respectively.

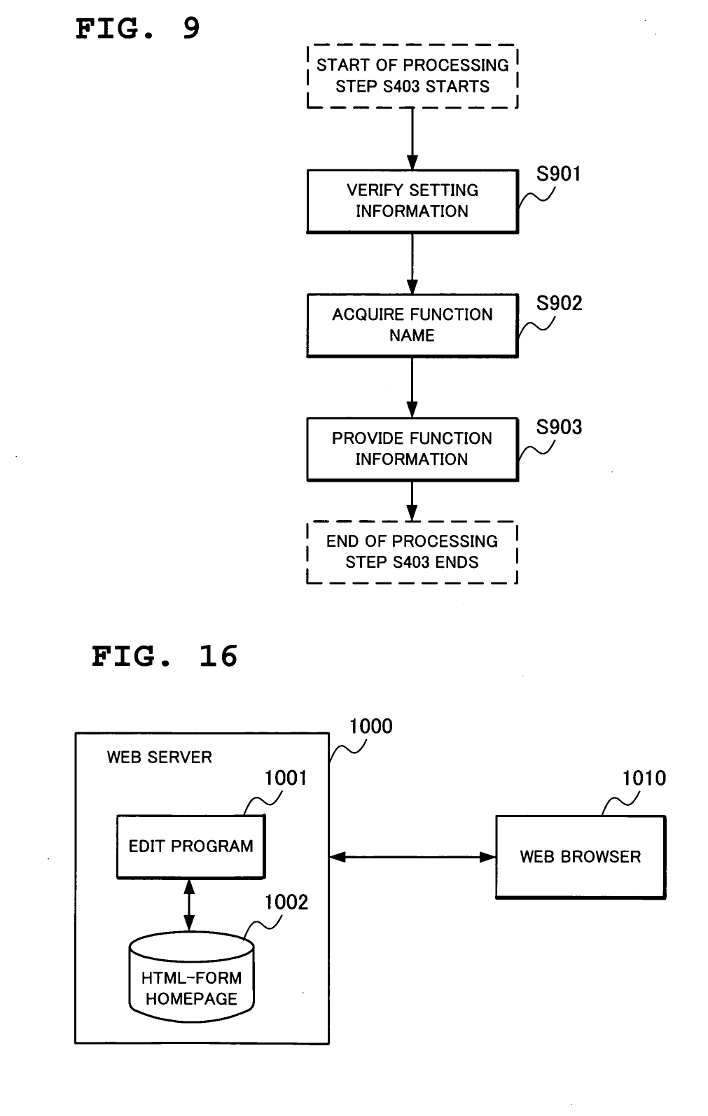

FIG. 9 is a flow chart which shows the function menu generation process, in step S703 above, performed by the client 200 according to this exemplary embodiment of the invention.

With reference to FIG. 9, the function menu generation unit 222 of the client operation control part 220 references the function menu setting information 241 in the storage part 240 and verifies the type corresponding to the plug-in point 703 (step S901).

The function menu setting information 241 contains, as described above, the type of plug-in point, the name of the function assigned to this plug-in point, the target URL which indicates directly or indirectly the location of the web content that provides this function.

To explain more specifically with reference to FIG. 2, this figure contains two types of plug-in point: “tel:link” and “mailto:link.” These indicate <A> tags wherein the URL schema specified by the href attribute are “tel:” or “mailto:,” respectively.

FIG. 2 also contains target URLs, which are shown as the information to indicate the location of the web content directly or indirectly. These may not necessarily be URLs, but rather may be realized by using information identified with character strings and causing it to be substituted with the corresponding URLs by the main server 100.

Once the function menu generation unit 222 of the client operation control part 220 verifies that the type of plug-in point to be dealt with is contained in the function menu setting information 131, it acquires the function name from the function menu setting information 131 (step S902) and provides it to the user interface part 210 (step S903). This completes the function menu generation process (step S703 ends).

On completion of the function menu generation process in step S703, that is, on receiving the function name needed to display the function menu, the user interface part 210 causes the output part 212 to display the function menu 706 on the web content screen 705 (step S704).

When the menu selected by the user from this function menu 706 is inputted (step S705), the user interface part 210 provides the function name selected from the function menu 706 to the client operation control part 220. Using the acquired function name, the client operation control part 220 searches for a match through the function menu setting information 1311 to 1315 within the function menu setting information 131 and acquires the target URL information set under this function name (step S706).

The client operation control part 220 causes the provided function determination unit 224 to determine whether the provided function is an external or internal function based on the acquired target URL information (step S707).

For example, the function is determined to be an external function if the target URL information begins with such character strings as “http:” and “https:.”

If the function is determined to be an external function in step S707, the web content request unit 221 of the client operation control part 220 issues a request for a web content to the URL directly or indirectly specified by the target URL information (step S708).

During this process, the attribute information for the plug-in point may be added as additional information, in the form of a request parameter.

Examples of such request parameter include a URL specified with a href attribute in the case where the plug-in point is an <A> tag, and partial URL information, which may be the telephone number section in the case of the tel schema type or the email address section in the case of the mailto schema type.

The process of acquiring a web content in step S708, which takes place after request information has been issued, is omitted from this description since it has already been described with reference to FIG. 5.

The communication control part 230 of the client 200 delivers the web content acquired from the main server 100 to the user interface part 210, and the user interface part 210 displays the newly acquired web content screen 707 on the output part 212 (step S701). On completion, the above-described steps are repeated.

On the other hand, if a link tag is selected directly while an input is being accepted in step S702, the direct selection function process is performed (step S709), instead of the process of invoking a function menu.

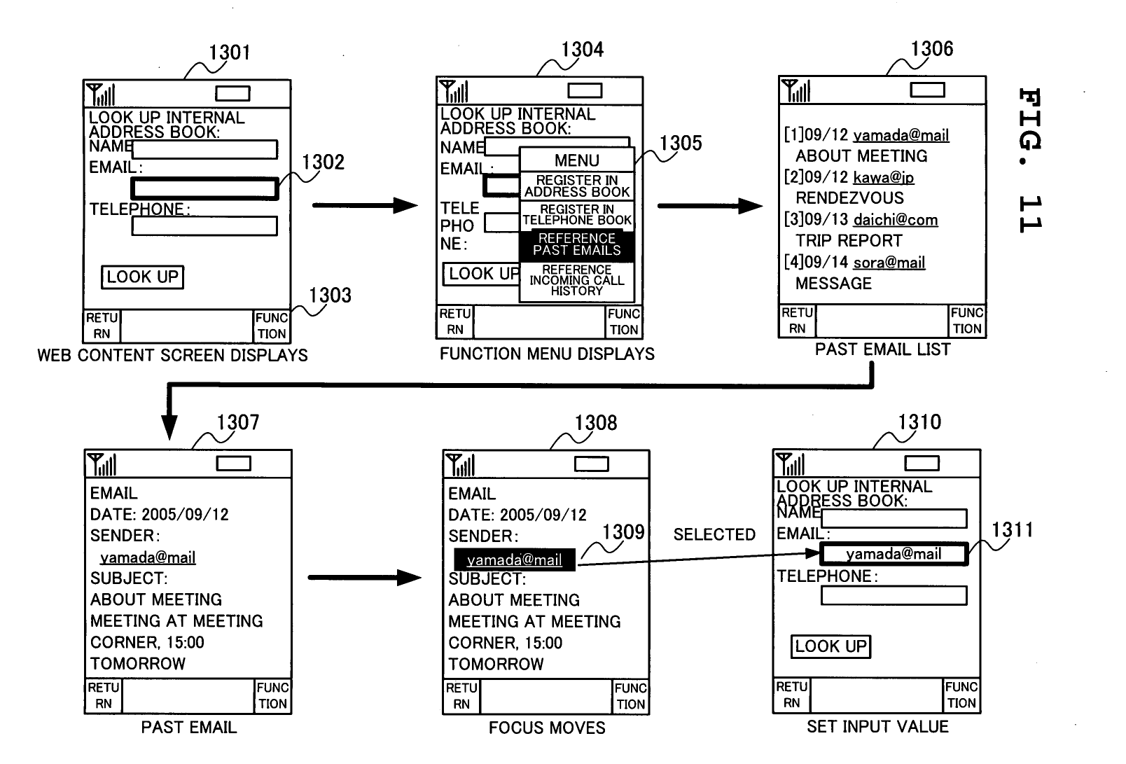

FIG. 10 is a flow chart which shows the direct selection function process performed by the client 200 according to this exemplary embodiment.

The direct selection function process (step S709) will now be described in detail with reference to FIG. 10.

When, in step S702, the user directly selects a link via the input part 211 of the user interface part 210, the direct selection function verification unit 223 of the client operation control part 220 verifies whether the corresponding setting is described in the direct selection function setting information 242 shown in FIG. 3 (step S1001).

The direct selection function setting information 242 contains, for example, a type and a target URL as shown in the direct selection function setting information 2421 and direct selection function setting information 2422 in FIG. 3.

Then, the direct selection function verification unit 223 searches through the direct selection function setting information 242 for a match with the information described in the link tag. If there is no match, it sets a determination flag which informs the user that the function directly selected by the user does not exist (step S1002).

This determination flag is used in step S710, described later, during the process of verifying the existence of the function directly selected by the user.

When the direct selection function verification unit 223 completes setting a determination flag indicating the absence of the desired function, the direct selection function process ends (step S709).

In step S1001, if there is a match with the type in the direct selection function setting information 242, the direct selection function verification unit 223 sets a determination flag which informs the user that the function directly selected by the user exists (step S1003).

When the direct selection function verification unit 223 acquires the target URL from the direct selection function setting information 242 (step S1004), the direct selection function process (step S709) ends (step 704).

This information of target URL will be used in step S708 above or step S711 below.

The direct selection function verification unit 223 then performs the process of verifying the existence of the function (step S710) by checking which determination flag, the one which indicates the absence of the function (step 707) or the one which indicates the existence of the function (step 702), has been set during the direct selection function process (step S709).

If a determination flag which indicates the absence of the function has been set, the function existence verification process (step S710) determines that there is no function that corresponds to the link tag directly selected by the user. The client returns to the display of the web content screen 702 (step S701) and waits for the next input (step S702).

If a determination flag which indicates the existence of the function has been set (S710), the provided function determination unit 224 references the target URL acquired from the direct selection function setting information 242 and performs the process of determining whether the function to be provided is an external or internal function (step S707). If the function to be provided is an external function, the provided function determination unit 224 proceeds to step S708 and acquires the request and content as described above. The process hereafter is the same as the one described above and thus is omitted from the description.

If in step S707 the provided function determination unit 224 determines that the function to be provided is an internal function as a result of referencing the target URL, it proceeds to the internal function execution process via the internal function execution unit 225 (step S711).

In step S707, the provided function determination unit 224 determines that the function to be provided is an internal function if it finds as a result of referencing the target URL that the target URL information begins with a character string “internal” or the like.

After the provided function determination unit 224 has determined that the function to be provided is an internal function in step S707, the internal function execution unit 225, in the internal function execution process (step S711), executes the internal function specified by the target URL contained in, for example, the direct selection function setting information 2422 within the direct selection function setting information 242 shown in FIG. 3.

For example, if the link is of “meilto:” type, the internal function execution unit 225 invokes and executes the email creation function held internally, using as the destination the email address specified in the link tag; if the link is of “tel:” type, it invokes the audio call function held internally and performs the call process, using as the destination the telephone number specified in the link tag.

On completion of the internal function execution process (step S711), the internal function execution unit 225 makes an instruction to terminate or continue the execution of the function being provided (step S712).

If the instruction made in step S712 is to continue the function being provided, the client displays the web content screen 702 which triggered the invocation of the internal function (step S701) and waits for the next input (step S702).

On the other hand, if the instruction made in step S712 is to terminate the function being provided, the execution of the function being provided is terminated.

While this exemplary embodiment has been explained by taking an example in which tags within a web content are used as plug-in points and a function menu is assigned to each of these tags, it is also possible to define the current web content itself as a plug-in point.

In this case, a possible approach is to assign a function menu based on the header information for a web content, e.g. URL or content-type, and to add such information as a parameter when invoking a function from the function menu being displayed in step S704.

Possible example applications of this function include a function which invokes a function to bookmark the current page, a function which invokes a function to print the current image or document and so forth.

In addition, while this exemplary embodiment has been explained by taking an example in which a function menu is generated when the focused link is selected, it is also possible to generate a function menu while a web content is being displayed.

In this case, on acquiring a web content from the communication control part 230, the client operation control part 220 verifies the tag information from the top of the web content and, if it determines a particular point to be a plug-in point, then it verifies whether or not there is a setting for that plug-in point in the function menu setting information 241.

If there is a setting for that plug-in point in the function menu setting information 241, the client operation control part 220 performs the process of assigning a function menu. When the assignment process is completed, it delivers to the user interface part 210 the web content up to the point where the assignment process has been completed. The user interface part 210 displays the web content according to the different tags contained. These steps are repeated until the end of the web content is reached. The function menu generation process thereafter is the same as the process which is performed in step S703 and on.

Another possible approach is to display a function menu at the same time as the display of a web content in the user interface part 210. Yet another is to, when the focus moves, display a function menu which corresponds to a link tag or other element in focus, for example, at the lower part of the web content screen being displayed in the user interface part 210.

Moreover, as a variation of this exemplary embodiment, it is possible to define as a plug-in point an event which occurs as a result of processing performed by the other functions of the client 200.

In this case, the target of monitoring during the process of waiting for an input in step S702 in FIG. 7 may not be limited to an input from the user. Rather, events which occur during processing performed by the other functions may also be the targets of monitoring and the process may be performed according to the first event generated.

For example, if the client 200 has a telephone function and if the client 200 gets an incoming call during the process of waiting for an input in step S702, this incoming event may be handled as a plug-in point. In this case, information which indicates “incoming event” as the type of plug-in point needs to be provided in the direct selection function setting information 242 in FIG. 3.

A telephone call incoming event occurs if the client gets a call during the process of waiting for an input in step S702. The client captures this event in step S702 and searches through the direct selection function setting information 242 for a match with the type of plug-in point which has occurred (in this case, a telephone call incoming event). If there is a match, the client acquires the target URL from the applicable item. The process of step S707 and thereafter is the same as the example described above.

Although in this description an incoming event is used as a plug-in point, it is also possible to use a call ending event as a plug-in point. Information associated with a plug-in point may include, for example, the telephone number of the caller, call incoming time and call ending time.

Another candidate of event that can be used as a plug-in point is a timer event, which occurs when a predetermined time has elapsed after the timer held internally by the client 200 is activated. For example, an event may be programmed to occur when a predetermined time has elapsed after the last input operation by the user.

Other events, such as a reception of information via an infrared interface held internally by the client 200 and a successful read by a barcode reader held internally by the client 200, may also be used as plug-in points.

### (Effects of the First Exemplary Embodiment)

According to this exemplary embodiment, the effects are achieved that the user's operability is not decreased even though the number of functions executed by the client 200 on a web content increases and that a web content screen can be displayed as intended by the creator of the content, because the main server 100 transmits in advance function setting information to the client 200 and because the client 200 holds the types of the functions which it can execute on a web content, together with the information which indicates the locations of these functions, and thus can invoke the selected function when the web content is displayed.

### Second Exemplary Embodiment

Next, a second exemplary embodiment of the invention will be described in detail with reference to FIGS. 7, 11, 12 and 13.

The second exemplary embodiment differs from the first exemplary embodiment in that it realizes plug-in points in a form which prompts input from the user, for example, by way of providing a text input field.

### (Configuration of the Second Exemplary Embodiment)

The configuration of the second exemplary embodiment will be omitted from the description below because it is the same as that of the first exemplary embodiment, except in that the user interface part 210 of the client 200 has plug-in points in a form which prompts input from the user, for example, by way of providing a text input field.

### (Operation of the Second Exemplary Embodiment)

The operation of this exemplary embodiment up to when it displays a display screen and specifies a function to be invoked by directly selecting the function in response to an input from the user or by selecting the function from a function menu is the same as the operation of the first exemplary embodiment which has been described with reference to FIG. 7.

The only difference between this exemplary embodiment and the first exemplary embodiment is the content of processing performed during the request/content acquisition process in step S708 in FIG. 7.

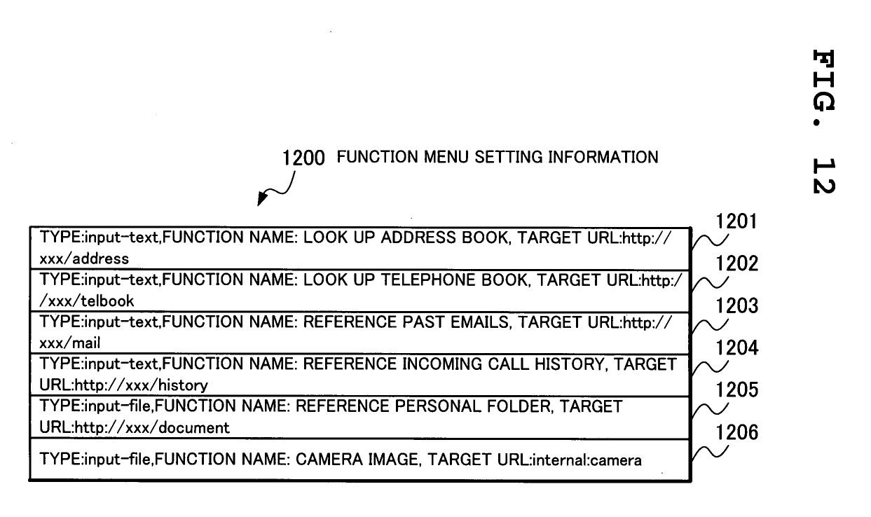

FIG. 11 shows a web content screen, which is an example display screen according to this exemplary embodiment.

With reference to FIGS. 7 and 11, the operation of this exemplary embodiment up to the request/content acquisition process in step S708 will be outlined below.

On the web content screen 1301 in FIG. 11 which is displayed during step S701 in FIG. 7, if the function selection key 1303 is pressed while the focus is in the “email” plug-in point 1302, the function menu generation process (step S703) is first performed and then the generated function menu is displayed (step S704). The display screen 1304 is an example of how it looks like when the generated function menu 1305 is displayed.

In the function menu generation process (step S703) mentioned above, a function menu is generated based on the attribute and the function menu setting information for the currently selected plug-in point 1302.

FIG. 12 shows an example of function menu setting information according to this exemplary embodiment.

This function menu setting information 1200 consists of function menu setting information 1201 to 1206 and, similarly to the first exemplary embodiment, is acquired in advance by the client.

As is shown in the web content screen 1301 in FIG. 11, at the time when the function menu generation process (step S703) is invoked, the focus is in the plug-in point 1302, which is a text input field associated with an <INPUT> tag with a type attribute of “Text” or the like.

The plug-in point 1302, which is a text input field, is a plug-in point with a type attribute of “input-text.” Because of this type attribute, it is assumed that, based on the function menu setting information 1200, a list has been generated which contains the function names of the functions whose “type” attribute is “input-text” (i.e., function menu setting information 1201 to 1204 in this exemplary embodiment).

The web content screen 1304 shows how the screen looks when the generated function menu 1305 is being displayed. If, for example, “Reference past emails” is selected, a determination between internal or external function is first made (step S707) . If it is an external function, the request/content acquisition process (step S708) is invoked.

During the function menu generation process in step S703, the functions which are currently held within the client but which have not been acquired from the function menu setting information 1200 may be added to the function menu held internally by the client in advance. The functions held internally by the client in advance and added to the function menu are executed as an internal function.

The operation of the request/content acquisition process (step S708), which is characteristic to this exemplary embodiment, will now be described in detail.

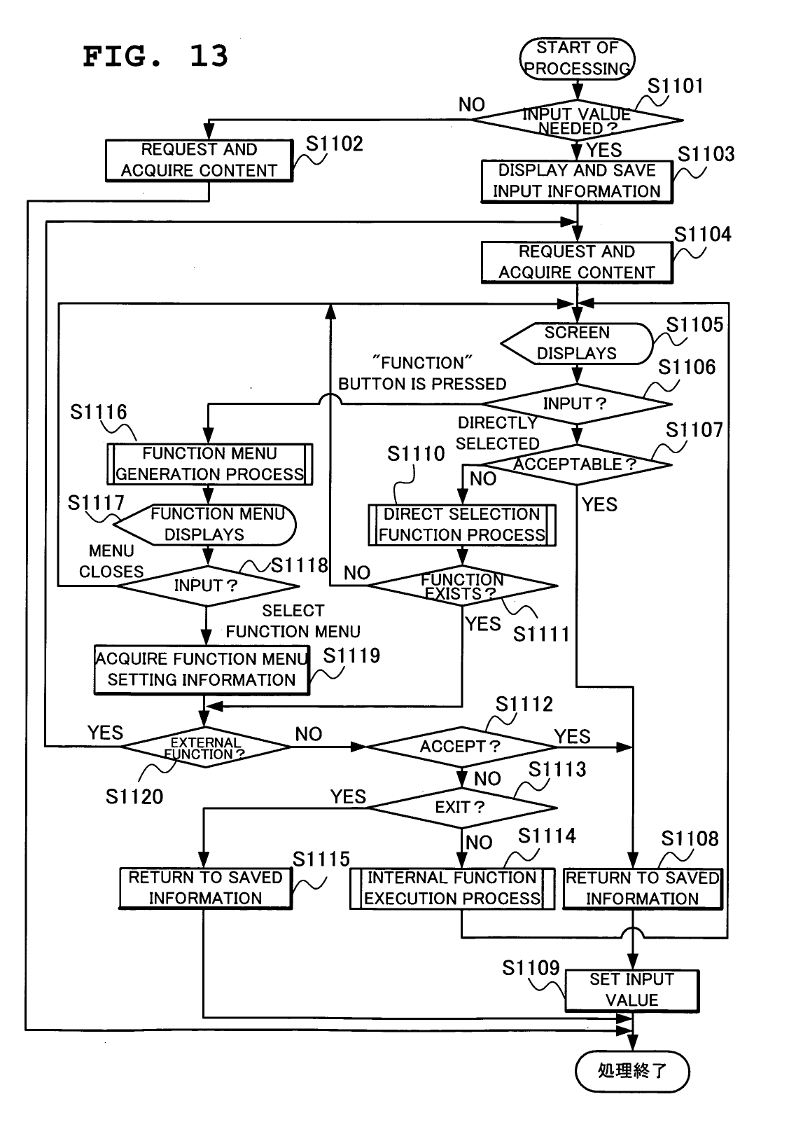

FIG. 13 is a flow chart which shows an example procedure performed by the client 200 according to the second exemplary embodiment during the request/content acquisition process (step S708).

As shown in FIG. 13, immediately after the request/content acquisition process begins, it is verified whether or not the plug-in point 1302 needs an input value (step S1101).

If the plug-in point 1302 does not need an input value, the operation that follows is the same as the operation described for the first exemplary embodiment. That is, a request for a web content is issued to the main server 100, and the web content sent in response to the request is acquired (step S1102), with which the process ends.

On the other hand, if the plug-in point 1302 is a plug-in point with a type attribute of “input-text,” the procedure proceeds to step S1103 because it needs an input value.

In step S1103, the information on the display screen and the text information already inputted by the user, for example, are saved as the information needed for restoring to the current operation state.

It should be noted that there may be cases where a plug-in point, which is the target of input, already has an input value. To deal with these cases, the confirmation process of asking the user to confirm whether or not the existing input value may be overwritten with a new value may be performed before proceeding to step S1103.

If the user does not confirm the overwriting in this confirmation process, the procedure may end without any further processing. Alternatively, the user may be given an option of adding a new input to the existing input value, in addition to the option of overwriting the existing input value. In this case, when the information is saved in step S1103, a flag to the effect that “a new value will ultimately be added” may also be saved, so that when a final input value is accepted and this input value is set (step S1109), a new input value will be added to, instead of overwriting, the existing input value.

These confirmation processes of asking the user to confirm whether or not the existing input value may be overwritten with a new value may be performed every time the user invokes this function. Alternatively, the user may previously be asked to set the timing at which the confirmation process is to be performed, so that the confirmation process will be performed according to such setting.

To summarize the above procedure briefly, after saving the information necessary for restoring to the current operation state in step S1103, the requested web content is acquired (step S1104) by issuing to the main server 100 a request for a web content associated with the selected function. This step is the same as step S1102.

Similarly to the first exemplary embodiment, the target URL for each of the selectable functions has already been identified directly or indirectly, based on the function menu setting information 1200 in FIG. 12 and the direct selection function setting information 242 in FIG. 3.

Referring to the web content screen 1304 in FIG. 11, it can be seen that “Reference past emails” in the function menu 1305 has been selected. Also referring to the function menu setting information 1200 in FIG. 12, it can be known from the corresponding function menu setting information 1203 that the target URL in this case is “http://xxx/mail.”

The client 200 displays the web content acquired by sending this URL to the main server 100 on the display screen via the output part 212 (step S1105).

The web content screen 1306 in FIG. 11 shows a display screen of a past email list, which is an example of display screen displayed in step S1105.

From this web content screen 1306, it is also possible to invoke the next web content screen by way of following the links or other similar actions.

This can be achieved by invoking the client 200's internal function to follow links, for example via the function menu generation process (step S1106→step S1116→step S1117→step S1118) or via the direct selection function process (step S1106→step S1107→step S1110→step S1111). Using this internal function, the client 200 may proceed from step S1120 through steps S1112 and S1113 to reach step S1114. During the internal function execution process in step S1114, the client 200 may issue a request for the linked web content to the main server 100, receive that web content in response to the request, and display a display screen using the acquired web content (step S1105).

The web content screen 1307 in FIG. 11 shows an example of display screen after the web content screen 1306 has changed to the next display screen.

In the description above, when the acceptance process is performed in step S1107 or S1112 in order to accept the value inputted at the plug-in point as an input value, the change from the web content screen 1306 which shows a past email list to the web content screen 1307 which shows a desired past email has been processed as a link between the display screens. This is because the acceptance process has judged that the link information for acquiring a new web content should not be used as an input value for the purpose of processing to be performed on a plug-in point with the input-text attribute.

This judgment during the acceptance process as to whether or not to use the link information as an input value depends on the type attribute of the plug-in point of interest.

A plug-in point with the input-text attribute according to this exemplary embodiment are provided with a schema local value, e.g. email address or telephone number, only if the link information for a web content is a URL of the mailto schema or tel schema. Therefore, such a schema local value may be defined to be used as an input value. Alternatively, a discrete schema, e.g. a text schema, may be provided and the value of the schema (portion after “text:”) may be defined to be used as an input value.

When such a link is selected, it is judged in the acceptance process in step S1107 or S1112 to accept the value as an input value and the procedure proceeds to step S1108. This takes place when an input value is accepted, for example, on the display screen 1308 which shows a state in which the link to the email address on the display screen 1307 has been selected into focus 1309. At this stage, a process may be provided to ask the user to confirm whether or not the value may be accepted as an input value before proceeding to step S1108.

In step S1108, the operation state is restored based on the information saved in step S1103, and then in step S1109 that follows, the accepted value is set in the source plug-in point 1302 on the web content screen 1301 (FIG. 11). This completes the request/content acquisition process in step S708.

If the procedure proceeds from the acceptance process in S1112 to step S1108, a function which has been determined to be an internal function in step S1120 is also executed in step S1108.

If the value inputted into the plug-in point is not accepted as an input value during the acceptance process in step S1112, a determination is made in step S1113 as to whether or not to exit this process. A determination in step S1113 may be made by, for example, providing a process to ask the user to confirm whether or not to exit this process.

If it is determined not to exit this process in step S1113, the function determined to be an internal function in step S1120 is executed in step S1115. On completion, the procedure returns to step S1105 and displays the display screen.

If it is determined to exit this process in step S1113, as in step S1108, the operation state is restored based on the information saved in step S1103, and the request/content acquisition process in step S708 ends.

When the procedure returns to step S701 and the display screen is displayed, the input value obtained by a series of function invoking processes shown in the web content screens 1301, 1304, 1306, 1307 and 1308 has been set in the plug-in point 1311, as shown in the web content screen 1310 in FIG. 11 which shows the input value setting screen.

During this function invocation process, a request for a web content is sent to the main server 100 to acquire the web content. At this time, the operation of the main server 100 may partially be changed by notifying the main server 100 that the function invocation process is in progress, at the same time as requesting the web content.

Also, as for links from one web content to another, it is possible to authorize links to specific web contents only, so that an error will be returned when an unauthorized web content is requested.

In addition, restrictions on functions within the client 200 may be added. For example, during the function menu generation process in step S1116, functions irrelevant to the determination of an input value may be excluded from the display.

With reference to FIG. 13, it is shown that the input value acceptance process is performed when a function is selected (i.e. immediately after direct selection or selection from the function menu). Instead, the input value acceptance process may be performed based on the content-type, filename or other information acquired as a result of issuing a request for a web content to the main server 100 during the content request/acquisition process in step S1104 or during the internal function execution process in step S1114. For example, if a plug-in point has an input-text attribute and if a web content requested is of a content-type of text/plain, then the text in the web content may be accepted as an input value in the plug-in point. Alternatively, part of the character strings in the web content being displayed may be cut out as an input value and the acceptance process may be performed on that value.

If the function subjected to a determination in step S1120 is an internal function, the input value may be accepted immediately after the execution of the internal function. For example, if the client 200 has a barcode reading function, the client may use a number in the read barcode as an input value for a plug-in point with the input-text attribute and perform the acceptance process on that value. If the client 200 has a character recognition function, the client may scan an image and use a character string obtained by performing character recognition on that image as an input value to accept.

While plug-in points with the input-type attribute which require input values were described in the examples above, <INPUT> tags in which the type attribute of web content is “file” may also be used as plug-in points.

The function setting information 1205, 1206 in FIG. 12 shows an example of using plug-in points with the input-file attribute and assigning functions to these plug-in points.

Each of these plug-in points with the input-file attribute specifies a file and can invoke a function to select the specified file from, for example, a document file held by the web server 300A or the web server 300B shown in FIG. 1.

Furthermore, if a web content is of a content-type which indicates an image or document, e.g. image/jpeg or application/octet-stream, then a filename may be accepted as an input value, or an image data or other similar data inputted by use of a device available to the client 200 such as a camera may be accepted as an input value.

### (Effects of Second Exemplary Embodiment)

According to this exemplary embodiment, since the user interface part 210 of the client 200 has plug-in points in a form which uses a text input field or other similar means to prompt input from the user, the client 200 can use more diverse functions to execute on web contents. Therefore, in addition to the effects of the first exemplary embodiment, this exemplary embodiment can provide the effects that the client 200 can enjoy grater flexibility in updating and adding functions to execute on web contents and that the client 200 can execute a more diverse array of function types.

### Third Exemplary Embodiment

(Configuration of the third Exemplary Embodiment)

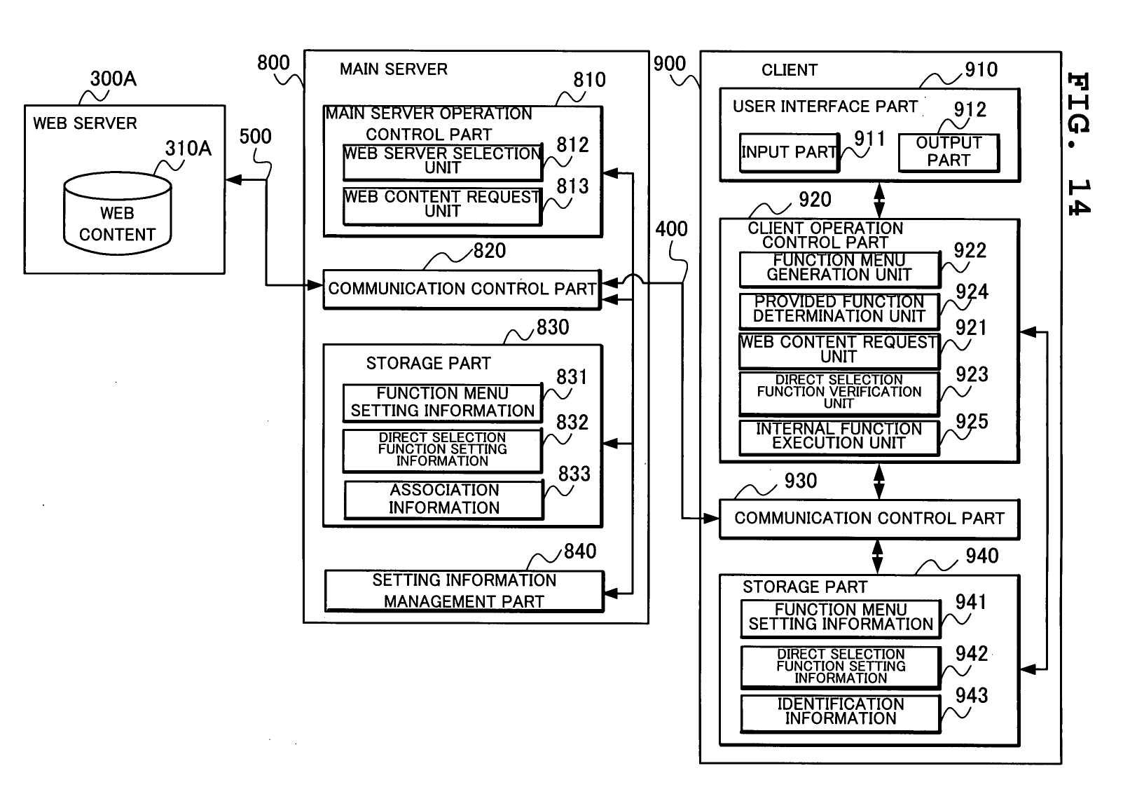

Next, a third exemplary embodiment of the invention will be described in detail with reference to FIG. 14, which is a block diagram showing the configuration of a communication system according to this exemplary embodiment.

The third exemplary embodiment is characterized by that the main server 800 provides the client 900 with function menu setting information 831 and direct selection function setting information 832 according to the identification information of the client 900.

The main server 800 according to this exemplary embodiment differs from the main server 100 according to the first exemplary embodiment in that it stores in the storage part 830 multiple sets of function menu setting information 831 and direct selection function setting information 832, each corresponding to each item of identification information 941. It also differs from the first exemplary embodiment in that it has a setting information management part 840 in place of the function menu setting information acquisition unit 111. Other components of the main server 800 have the same configurations and functions as the corresponding components of the main server 100.

The storage part 830 stores association information 833 which indicates associations between identification information 943 and function menu setting information 831, and associations between identification information 943 and direct selection function setting information 832.

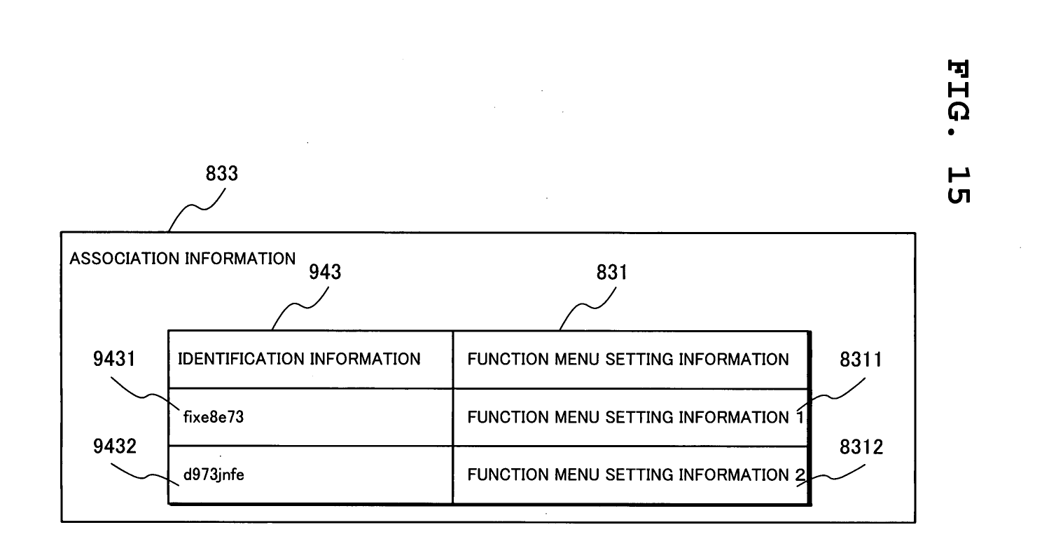

FIG. 15 is an example of association information 833. This example shows association information which indicates associations between identification information 943 and function menu setting information 831 held by the storage part 830.

With reference to FIG. 15, the association information 833 indicates association between function menu setting information 831 and identification information 943; more specifically, it indicates associations between function menu setting information 8311/function menu setting information 8312 and identification information 9431/identification information 9432, respectively.

The setting information management part 840 has a function to, based on the identification information 943 received from the client 900, look up the storage part 830 to identify associations between identification information 943 and function menu setting information 831 and then to acquire the identified function menu setting information 831 from the storage part 830.

The client 900 according to this exemplary embodiment differs from the client 200 according to the first exemplary embodiment in that it has identification information 943 in the storage part 940. Other components of the client 900 have the same configurations and functions as the corresponding components of the client 200.

Identification information 943 is a unique information with which the client 900 requesting for a web content can be identified, examples of which including a user ID, user agent information and telephone number.

### (Operation of the Third Exemplary Embodiment)

It is assumed that the client 900 holds identification information 943 and adds the identification information 943 to the web content request parameter or HTML header of each request for a web content.

The storage part 830 of the main server 800 needs to previously store association information 833, which indicates associations between identification information 943 and function menu setting information 731 and associations between identification information 943 and direct selection function setting information 832.

There are several possible methods for registering such information. Firstly, information may previously be provided by the user of the client 900 to the administrator of the main server 800. Secondly, it may be registered during the download of an application for use by the client 900 when using the method of the invention. Thirdly, when the client 900 accesses the main server 700 for the first time, the client 900 may be provided a web content for registration for prompting input by the user. However, the registration method is irrelevant to this exemplary embodiment, and thus will be omitted from the description below.

When the client 900 issues a request for a web content via the communication control part 930 to the main server 800, the communication control part 820 of the main server 800 receives the web content request, acquires the identification information 943 from the request parameter or the HTML header contained in the web content request, and provides that information to the setting information management part 840.

On receiving the identification information 943, the setting information management part 840 searches through, for example, the function menu setting information 831 stored in the storage part 830, and identifies and acquires the function menu setting information associated with this identification information 943.

The setting information management part 840 transmits as a response the acquired function menu setting information to the client 900 via the communication control part 920.

On acquiring the function menu setting information, the communication control part 930 of the client 900 saves the acquired function menu setting information as function menu setting information 941.

Function menu assignment and other processes thereafter are realized by similar processes to those in the first exemplary embodiment.

Through the procedure above, it becomes possible for the client 900 to acquire the appropriate function menu setting information.

### (Effects of the Third Exemplary Embodiment)

As described above, the main server 800 according to this exemplary embodiment has function menu setting information to be used by the user of the client 900, and previously holds in the storage part 840 the association information 833 which indicates association between the identification information 943 identifying the client 900 used by the user and the function menu setting information to be used by the client 900 and which indicates association between the identification information 943 and the direct selection function setting information to be used by the client 900. In this state, the main server 800 receives a request for a web content from the client 900 and acquires the identification information 943 at the setting information management part 840 via the communication control part 920 of the main server 800. The main server 800 then acquires, for example, the function menu setting information to be provided to the client 900 from within the association information 833 in the storage part 830, and transmits as a response the acquired function menu setting information to the client 900.

Therefore, when receiving the function menu setting information, the client 900 can utilize the function menu by performing thereafter the same procedure as described above for the first exemplary embodiment. By this, it becomes possible for the administrator of the main server 800 to receive from the client 900 a fee for providing the information.

The storage part 830 of the main server 800 may hold direct selection function setting information associated with identification information 943, rather than function menu setting information 831 associated with identification information 943, or may hold both. Similarly, the main server 800 may provide to the client 900 direct selection setting information associated with identification information 943 only, or both of function menu setting information and direct selection setting information, each associated with identification information 943.

In this case, based on the identification information 943 of the client 900, it is possible for the main server 800 to provide different function menu setting information 831 to different clients 900, or provide different direct selection function setting information 942 to different clients 900.

In particular, according to this exemplary embodiment, when a main server operating company which operates the main server 800 of the invention to provide the above-described information to a client 900 utilized by a contract firm under a contract with the main server operating company, the main server operating company can modify the information stored in the storage part 830 based on the identification information 943 of the client and provide the resultant function menu setting information and/or direct selection function setting information to the contract firm. By this, it becomes possible for the main server operating company to provide functions to a contract firm by more flexibly associating between the contract firm and functions.

The reason for this effect is that the main server operating company can identify a contract firm based on identification information 943 and provide different functions corresponding to different contract firms from among the functions of the main server 800, i.e. a service provider.

As described above, according to this exemplary embodiment, the main server transmits function setting information to the client in advance, and the client previously holds the types and locations of the functions to be executed on the web contents. Using this information, the client invokes the selected function when displaying a web content.

According to the exemplary embodiments of the invention, the user's operability does not decrease even when the number of function increases, and the display screen is displayed as intended by the creator of the web content. This is because the main server provides to the client the function setting information which contains the types and locations of the functions available on a web content. When executing a web content, the client invokes a function based on the function's location information in the function setting information acquired from the main server and executes the function on the web content.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### Incorporation by Reference

This application is based upon and claims the benefit of priority from Japanese patent application No. 2005-318508, filed on Nov. 1, 2005, the disclosure of which is incorporated herein in its entirety by reference.

1. A network system in which a main server receives a request for a content from a client connected with the main server via the network, acquires said content from a content server and provides the content to said client, wherein
said main server providing to said client at least one of first function setting information which contains information indicating the types and locations of functions available for execution by said client on said content and second function setting information which contains information indicating the types, function names and locations of functions available for execution by said client on said content; and
said client executing said content and executing on said content said function which the client has invoked based on the information which indicates the location of said function and which is contained in said first or second function setting information acquired from said main server.

2. The network system of claim 1, wherein
said main server provides said second function setting information to said client,
said client executes said content and presents said functions available for execution on said content based on the function setting information acquired from said main server, and
the client invokes said function selected from said presented functions, based on the information which indicates the location of said function, and executes the function on said content.

3. The network system of claim 1, wherein
the type of the function available for execution by said client on said content depends on the plug-in type of the function, and
a plug-in point, an area in which said plug-in is established, represents said web content itself or one or more of the display elements on said web content.

4. The network system of claim 1, wherein
said client presents list information which indicates functions available for execution by the client on said content for each plug-in type, based on said second function setting information.

5. The network system of claim 3, wherein
said plug-in point includes a link tag, and
said client executes on said content said function invoked based on the location information for said function which is mapped to a type of said plug-in, which type being associated with a specific schema type in the link-to information indicated by said link tag.

6. The network system of claim 3, wherein
said plug-in point includes a link tag, and
said client,
in the case of a link of the schema type of “tel” or “mailto” as indicated in the link-to information acquired from the location of said first function invoked based on said first or second function setting information,
executes on said content said second function, which is mapped to a new type of the plug-in associated with said “tel” or “mailto” link and which has been invoked based on the location information for the second function.

7. The network system of claim 3, wherein
said plug-in point includes a link tag, and
said client
in the case of a link of the schema type of “file,” which includes at least any one of document file, audio file, still image file and moving image file, as indicated in the link-to information from the location of said first function invoked based on said first or second function setting information,
executes on said content said second function, which is mapped to a new type of said plug-in associated with said “file” link and which has been invoked based on the location information for the second function.

8. The network system of claim 3, wherein
said client
as a value acquired as a result of executing the first function, uses the data of still image or moving image acquired by using a photograph function incorporated into said client, or the data of character string acquired by using a photograph function incorporated into said client, together with a character recognition function or barcode recognition function added thereto, based on the location of said first function to execute as shown from said first or second function setting information, and
executes on said content said second function which has been invoked based on the location information for the second function, which function being mapped to a new type of said plug-in associated with said value.

9. The network system of claim 1, wherein
said client
has a plug-in associated with a specific operation event of said client, and on occurrence of said operation event, executes on said content said function which has been invoked, based on said first or second function setting information, and based on the information which indicates the location of said function mapped to the type of said plug-in, which plug-in type being associated with said operation event that has occurred.

10. The network system of claim 1, wherein
said client
has a telephone function and therefore has a plug-in which is associated with at least either of call incoming and call ending operation events, and
on occurrence of said call incoming or call ending operation event, executes on said content said function which has been invoked, based on said function setting information, and based on the information which indicates the location of said function mapped to the type of said plug-in, which plug-in type being associated with said call incoming or call ending operation event that has occurred.

11. The network system of claim 1, wherein
said client
has a time function and therefore has said plug-in which is associated with said operation event which occurs on the elapse of a pre-determined time from the activation of the timer, and
on occurrence of said operation event when the pre-determined time has elapsed, executes on said content said function which has been invoked, based on said function setting information, and based on the information which indicates the location of said function mapped to the type of said plug-in, which plug-in type being associated with said operation event that occurred on the elapse of the predetermined time from the activation of the timer.

12. The network system of claim 1, wherein
said client
executes on said content the first function which has been invoked based on said first or second function setting information, which information being acquired from the main server on said network, and
executes on said content said second function which has been invoked based on the location information for the second function, which function being mapped to a new type of said plug-in associated with the value acquired as a result of executing said first function.

13. The network system of claim 3, wherein
said plug-in point is an area with a character information input function, within a context on said content acquired via said network, and
the type of the plug-in selected at said plug-in point is determined based on the character information inputted in said area.

14. The network system of claim 13, wherein
said character information includes a filename, and
the type of said plug-in is determined based on the filename inputted in said area.

15. The network system of claim 1, wherein
said client
issues a request for said content to said main server by adding the attribute information for the plug-in as a parameter.

16. The network system of claim 1, wherein
said client
displays said content acquired from said content server via said network, and presents said functions available for execution by said client on said content based on said first or second function setting information acquired from said main server.

17. The network system of claim 1, wherein
said first or second function setting information directly indicates the locations of the functions available for execution by said client on said content, and
said client issues a request for the execution of one of said functions, directly to the location of said function.

18. The network system of claim 1, wherein
said first or second function setting information indicates the location of the server on said network, which identifies the location of the function to be executed by said client on said content, and
said server identifies the location of said function to be executed by said client on said content based on the request for the execution of said function received from said client, and provides to said client said function itself or the location of said function.

19. The network system of claim 1, wherein
said main server holds identification information which identifies said client and at least one of said first and second function setting information in association with each other, and, based on said identification information, provides to said applicable client said first or second function setting information, whichever corresponds to said client.

20. The network system of claim 19, wherein
said identification information is user identification information which identifies the user of said client.

21. The network system of claim 1, wherein
a main server operating company which operates said main server provides to a client utilizing firm which utilizes said client having said identification information assigned thereto at least either of said first or second function setting information which is associated with said client, based on said identification information.

22. A server in a network system in which said server receives a request for a content from a client connected with the server via the network, acquires said content from a content server and provides the content to said client, wherein
providing to the client at least one of first function setting information which contains information indicating the types and locations of functions available for execution by said client on said content and second function setting information which contains information indicating the types, function names and locations of functions available for execution by said client on said content.

23. The server of claim 22, wherein
the server identifies the location of said function to be executed by said client on said content based on the request for the execution of said function received from said client, and provides to said client said function itself or the location of said function.

24. The server of claim 22, wherein
the server holds identification information which identifies said client and said function setting information in association with each other; and
based on the request for the execution of said function received from said client and the identification information for said client, provides to said client at least one of said first and second function setting information which corresponds to said client.

25. A client in a network system in which a main server receives a request for a content from a client connected with the server via the network, acquires said content from a content server and provides the content to said client, wherein
executing said content and executing on said content the function which the client has invoked based on the information which indicates the location of said function, which information being included in the function setting information which is acquired from said main server and which contains information indicating the type and location of said function available for execution by said client on said content.

26. A program executed on a main server in a network system in which the main server receives a request for a content from a client connected with the main server via the network, acquires said content from a content server and provides the content to said client, comprising the processing of:
providing to said client at least one of first function setting information which contains information indicating the types and locations of functions available for execution by said client on said content and second function setting information which contains information indicating the types, function names and locations of functions available for execution by said client on said content.

27. The program of claim 26, wherein
the program has a function to identify the location of said function to be executed by said client on said content based on the request for the execution of said function received from said client and to provide to said client said function itself or the location of said function.

28. The program of claim 26, wherein
the program holds identification information which identifies said client and said function setting information in association with each other, and, based on the request for the execution of said function received from said client and the identification information for said client, provides to said client said first and second function setting information which corresponds to said client.

29. A program executed on a client in a network system in which a main server receives a request for a content from said client connected with the main server via the network, acquires said content from a content server and provides the content to said client, comprising the processing of:
executing said content and executing on said content said function which the client has invoked based on the information which indicates the location of said function, which information being included in the function setting information which is acquired from said main server and which contains information indicating the type and location of the function available for execution by said client on said content.

30. A web browsing function realizing method for a network system in which a main server receives a request for a content from a client connected with the main server via the network, acquires said content from a content server and provides the content to said client, comprising the step of:
said main server providing to said client at least one of first function setting information which contains information indicating the types and locations of functions available for execution by said client on said content and second function setting information which contains information indicating the types, function names and locations of functions available for execution by said client on said content.

31. The web browsing function realizing method of claim 30, comprising the step of:
said main server identifying the location of said function to be executed by said client on said content based on the request for the execution of said function received from said client and providing to said client said function itself or the location of said function.

32. The web browsing function realizing method of claim 30, comprising the step of:
said main server holding identification information which identifies said client and said function setting information in association with each other, and, based on the request for the execution of said function received from said client and the identification information for said client, providing to said client said first and second function setting information which corresponds to said client.

33. A web browsing function realizing method for a network system in which a main server receives a request for a content from a client connected with the main server via the network, acquires said content from a content server and provides the content to said client, comprising the step of:
said client executing said content and executing on said content said function which the client has invoked based on the information which indicates the location of said function, which information being included in the function setting information which is acquired from said main server and which contains information indicating the type and location of the function available for execution by said client on said content.
